(19) United States
(12) Patent Application Publication
(10) Pub. No.: US 2014/0352200 A1
(43) Pub. Date: Dec. 4, 2014

(54) Insect Killing Apparatus and Method of Construction

(71) Applicant: Craig TREMBLE, (US)

(72) Inventor: Craig Tremble, Sherwood (AU)

(21) Appl. No.: 14/372,492

(22) PCT Filed: Feb. 13, 2013
(86) PCT No.: PCT/AU2013/000119

§ 371 Date: Jul. 16, 2014

(30) Foreign Application Priority Data
Feb. 13, 2012 (AU) 2012900522
Mar. 2, 2012 (AU) 2012900821

(51) Int. Cl. A01M 1/22; A01M 1/04

(52) U.S. Cl. CPC A01M 1/223; A01M 1/04
USPC 43/112; 43/113

(57) ABSTRACT

An insect killing apparatus is provided in the form of a compact fluorescent light. The light has a base that defines a compartment for a first electric circuit for applying current to fluorescent tubes of the light. An electrical connector for attachment to an electricity power supply socket also extends from the compartment. The killing apparatus also includes a second electric circuit within the compartment arranged to produce a potential difference capable of killing insects such as mosquitoes. First and second spaced apart electrodes are disposed about the fluorescent tubes and in electrical communication with the second electric circuit.

### TECHNICAL FIELD

The present invention is directed to an electric apparatus of compact form that is convenient to install and which is able to shed light and kill insects.

### BACKGROUND ART

Any references to methods, apparatus or documents of the prior art are not to be taken as constituting any evidence or admission that they formed, or form part of the common general knowledge.

Mosquito borne diseases, such as malaria, Ross River Fever and Dengue Fever are causes of severe morbidity and in some cases death. Consequently it is important that cost effective devices be available to reduce the number of mosquitoes and other insects.

FIG. 1 depicts a prior art insect killing apparatus 2 or as they are often called, a “zapper”.

The apparatus 2 comprises a metal support frame 4 which supports one or more electric lights 6. Around the lights there are disposed two spaced electrodes in the form of coils 8 which in use are charged so that a high potential difference exists between them in order that an insect, for example a mosquito, making contact with both coils will be electrocuted.

The apparatus 2 further includes a ring or hook 10 fitted to the top of support frame 4 so that it may be hung in a suitable position. The version of the apparatus shown in FIG. 1 is portable so that its base is formed to accommodate batteries for powering the apparatus as well as circuitry for powering the electric lights and coils from the batteries.

One of the disadvantages with an insect killing apparatus of this type is that the batteries must be replaced and a suitable hook or other support member must be found to support ring 10. Where the apparatus 2 is of a type that is not fitted with batteries, but rather makes use of an electrical cord for connection to a domestic power supply, then a conveniently placed electrical outlet must be located.

Furthermore, the metal support frame 4 is somewhat heavy and relatively expensive to manufacture.

It would be advantageous if a more compact and readily installed device could be provided.

### SUMMARY OF THE INVENTION

According to a first aspect of the present invention there is provided an
insect killing apparatus comprising:
a compact fluorescent light of a type including
a base defining a compartment containing a first electric circuit arranged to apply current to one or more fluorescent tubes of the light; and
an electrical connector coupled to the first electric circuit for attachment to an electric power supply outlet;
said killing apparatus further comprising;
a second electric circuit within the compartment arranged to produce a potential difference sufficient to kill a mosquito; and
first and second spaced apart electrodes disposed about said tubes and in electrical communication with the second electric circuit.

Preferably one or more support members extend from the base for supporting the first and second electrodes.

The first and second electric circuits may share a common circuit board or alternatively they may be disposed on corresponding separate circuit boards.

Preferably the the electrodes comprise coils and the apparatus includes an arrangement for spacing the coils from the fluorescent tubes.

For example, the arrangement for spacing the coils from the fluorescent tubes may comprise a plurality of radial fins.

The apparatus may also include a safety cover fitted about the electrodes.

According to a further aspect of the present invention there is provided a method for making an electric insect killing machine comprising the steps of:
locating a coil energizing circuit within a base compartment of a compact fluorescent lamp;
disposing a pair of spaced apart electrodes about fluorescent tubes of said lamp; and
placing the spaced apart electrodes in electrical communication with the coil energizing circuit.

According to a further aspect of the present invention there is provided an insect killing apparatus comprising:
a base containing a first electric circuit arranged to power an electric light, the base including a socket for receiving an electricity plug of said electric light;
an electrical connector extending from the base for attachment to an electricity supply power outlet;
the base further including;
a second electric circuit within the compartment arranged to produce a potential difference capable of killing mosquitoes; and
first and second spaced apart electrodes extending from the base and in electrical communication with the second electric circuit.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a prior art electric insect killing apparatus.

FIG. 2 is an insect killing apparatus according to a first embodiment of the present invention.

FIG. 3 depicts a base compartment of the insect killing apparatus of FIG. 2.

FIG. 4 is a view of a partially assembled insect killing apparatus according to a second and preferred embodiment of the present invention.

FIGS. 5 and 6 are further views of the insect killing apparatus of FIG. 4 in a further state of assembly.

FIG. 7 depicts an insect killing apparatus according to a preferred embodiment of a further aspect of the invention.

### DETAILED DESCRIPTION OF PREFERRED EMBODIMENTS

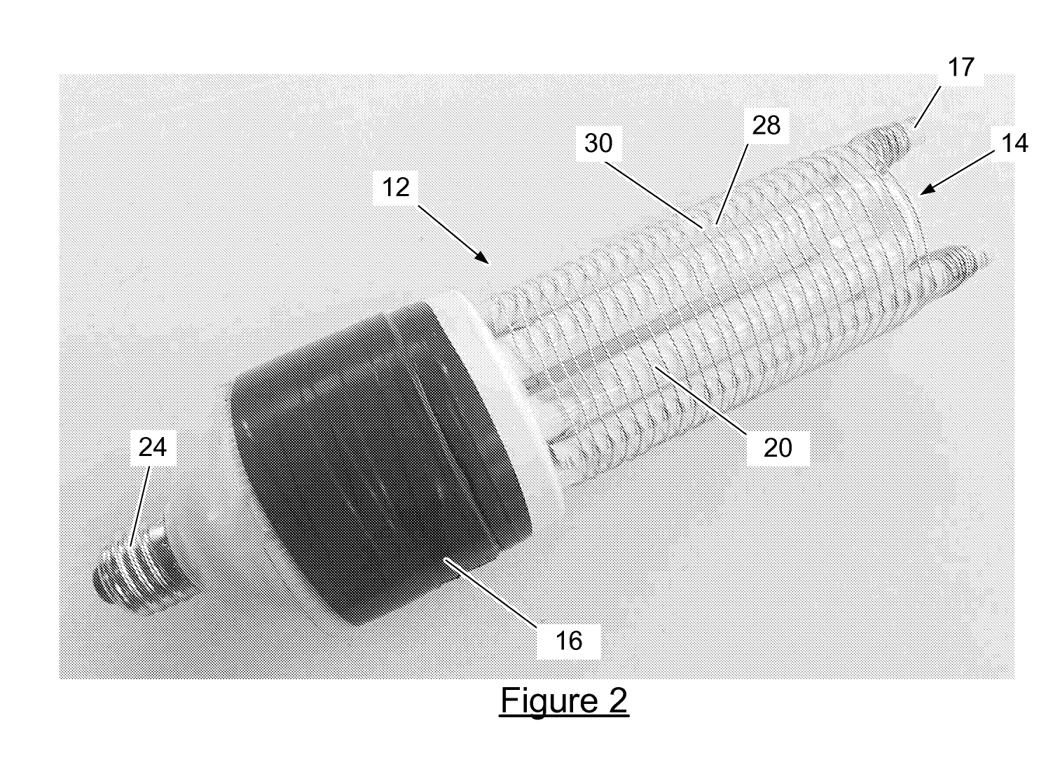

Referring initially to FIG. 2, there is depicted an insect killing apparatus 12 according to a preferred embodiment of the present invention.

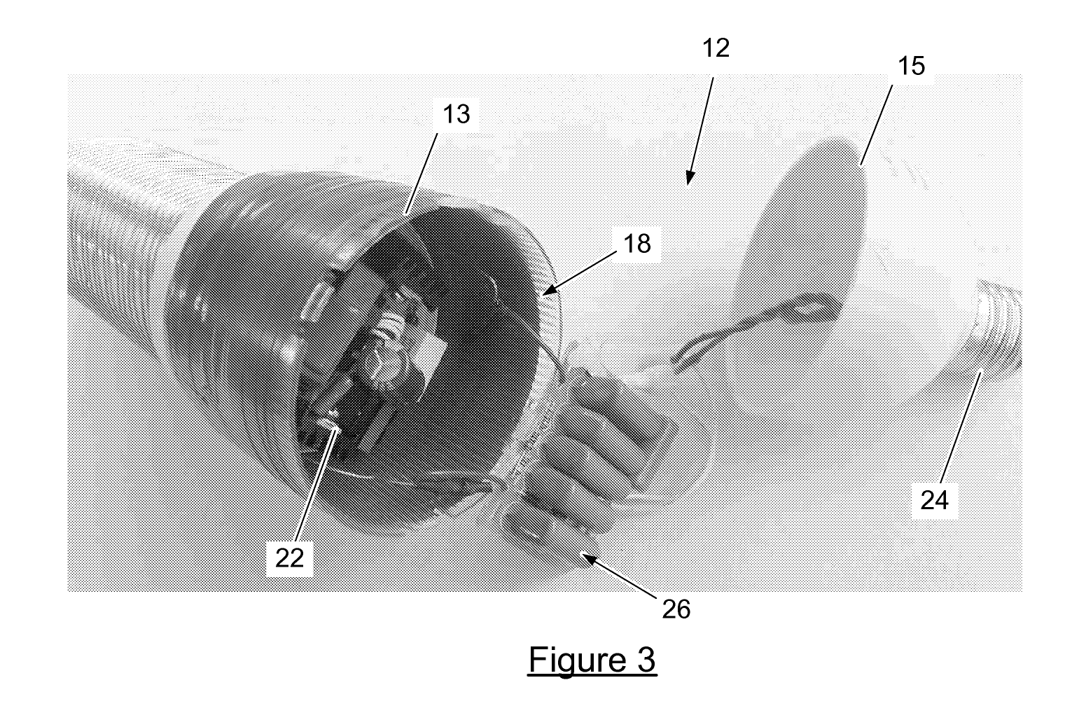

The apparatus 12 comprises a compact fluorescent light 14 of a type including a base 16. The base 16 is formed of two opposing portions 13, and 15 which are shown in FIG. 3 and which cooperate to define a compartment 18. The interior of compartment 18 can be seen in FIG. 3. A number of support, posts 17 extend from one side of the base about fluorescent tubes 20. The support posts 18 support a pair of spaced apart electrodes in the form of coils 28 and 30 which are coiled around the fluorescent tubes 20. While electrodes in the form of spaced apart coils are shown in the preferred embodiment, other types of electrodes, for example grids of wire are also possible and envisaged in alternative embodiments of the invention. The fluorescent tubes 20 also extend from the base 16 and are electrically connected to a first electric circuit 22 which is housed within the compartment 18 and arranged to energize the tubes so that they produce light.

An electrical connector 24, for attachment to an electric power socket also extends from the compartment, opposite the fluorescent tubes.

As shown in FIG. 3, the insect killing apparatus 12 further comprises a second electric circuit 26 within the compartment 18. The second electric circuit 26 is coupled to coils 28 and 30 (FIG. 2) and is arranged to produce a potential difference across the coils sufficient to kill an insect, such as a mosquito that comes into contact with both coils.

It will be noted that the first circuit 22, for energizing the fluorescent tubes, is mounted to a first circuit board and the second circuit, for energizing the coils, is mounted to a second circuit board.

In an alternative embodiment of the invention the first and second electric circuits may share a common circuit board or other support structure.

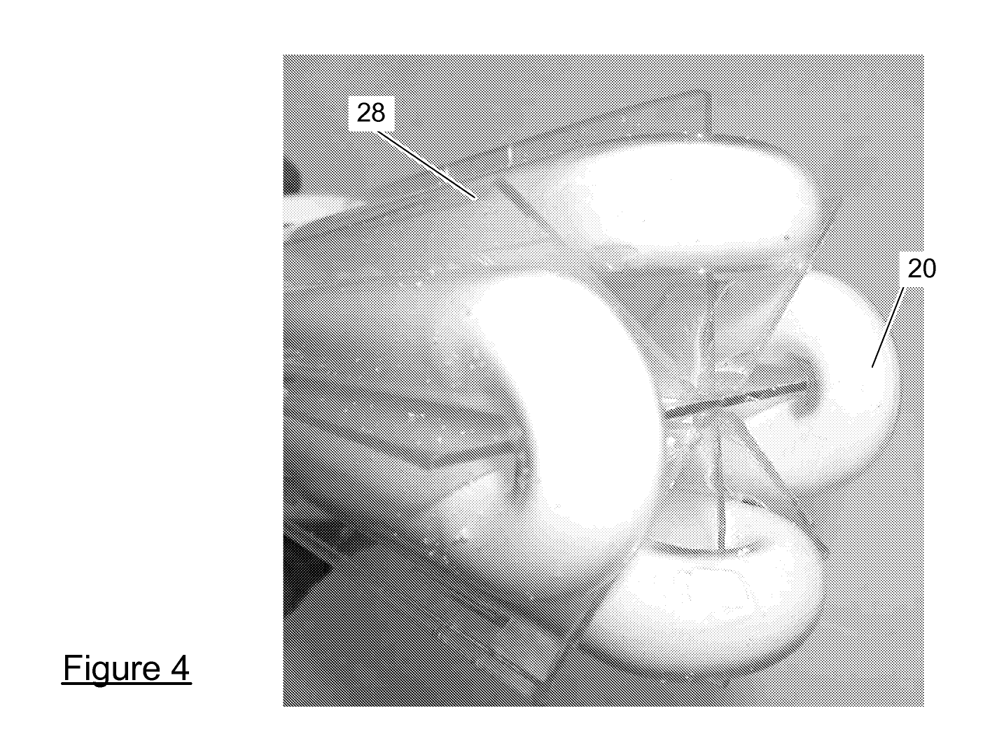

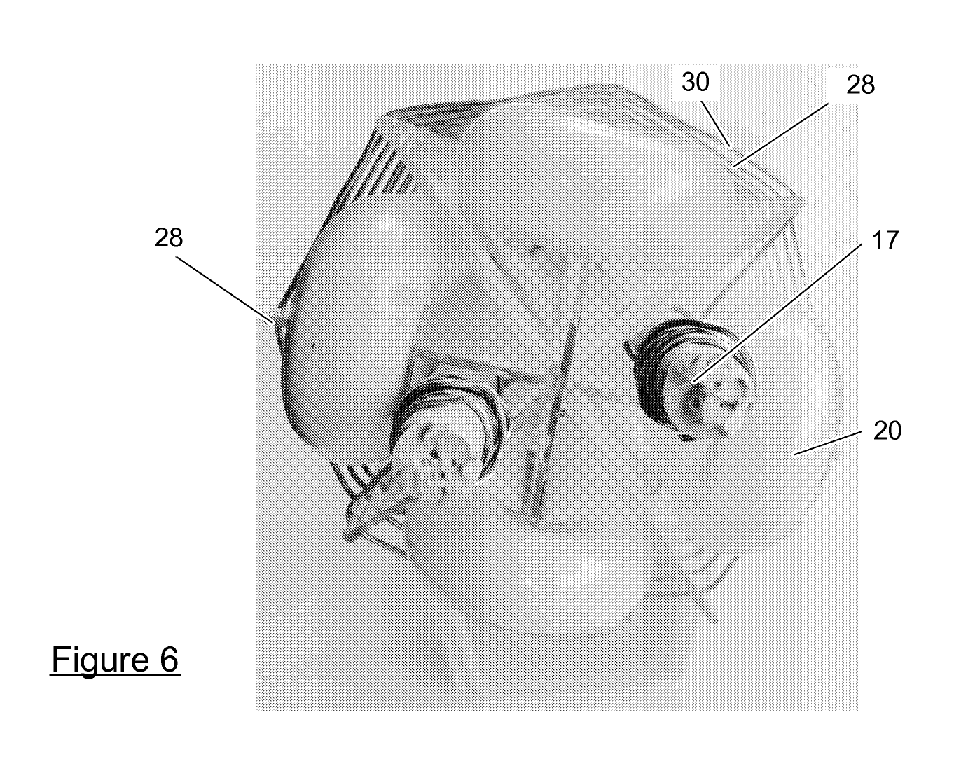

In the first embodiment of the invention that has been described with reference to FIGS. 2 and 3, the coils 28 and 30 come into contact with the fluorescent tubes 20 which is undesirable since it produces wear of both the tubes and the coils. In a second a second, and preferred embodiment of the invention, which will now be described with references to FIGS. 4 to 6 this problem is overcome.

Referring now to FIG. 4, a polar array of eight fins 28 is located to radiate outwardly from the centre of the fluorescent tubes 20 so that the fins extend beyond the tubes.

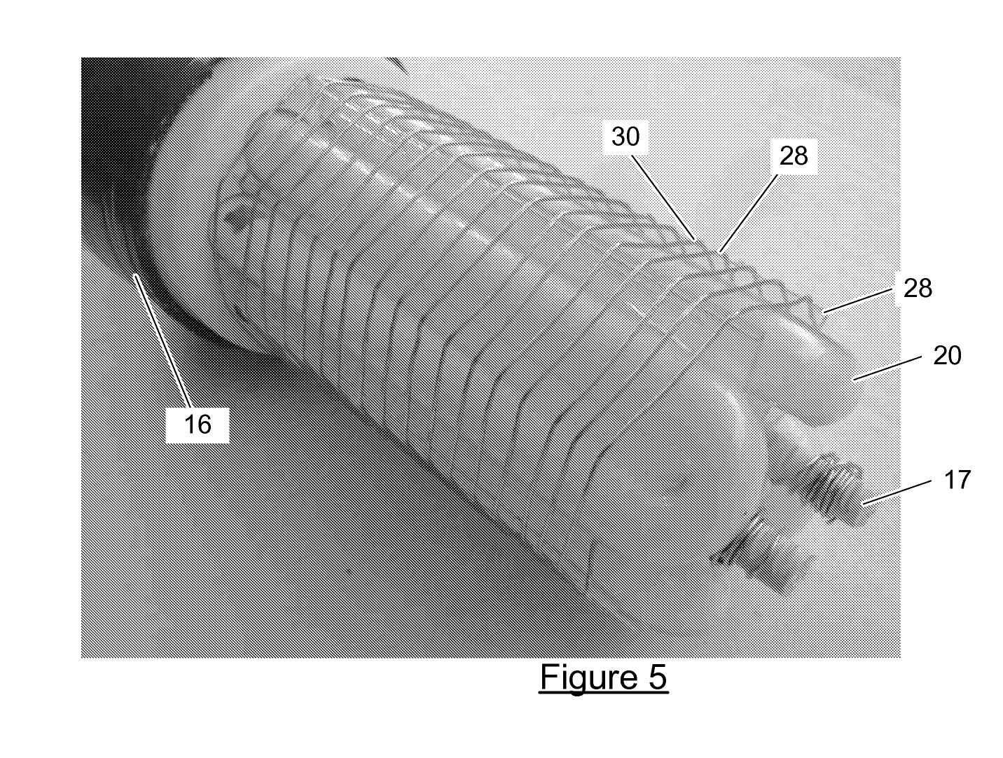

As shown in FIG. 5, the coils 28 and 30 are wound about the outside edges of the fins 28 so that they are kept from contact with the fluorescent tubes 20. The edges of the fins may be notched to hold the coils therein and so prevent them moving up and down the edges of the fin.

In a further embodiment of the invention a safety cover is provided (not shown) which is fitted about the coils and mounted fast with the base 16. Preferably the safety cover comprises a plastic, non electrically conductive material that is clear to light and which has holes formed through it that are large enough for the passage of flying insects such as mosquitoes.

In use an insect killing apparatus according to an embodiment of the present invention may be directly fitted to a conventional light fitting by means of connector 24.

Whilst a screw-in connector is shown in FIG. 4 a bayonet or other type of suitable connector might equivalently be used.

Consequently, both the fluorescent tubes and the opposed coils are energized simultaneously upon switching on the wall mounted light switch for the light fitting.

It will be appreciated that there is no need to find a hook or other suitable mounting point as is the case with many prior art electrical insecticide apparatus that make use of coils and lights.

An apparatus according to the invention may be manufactured by retrofitting an existing off the shelf compact fluorescent light, as is the case with the embodiments shown in the Figures. Alternatively, the apparatus may be custom built in a factory.

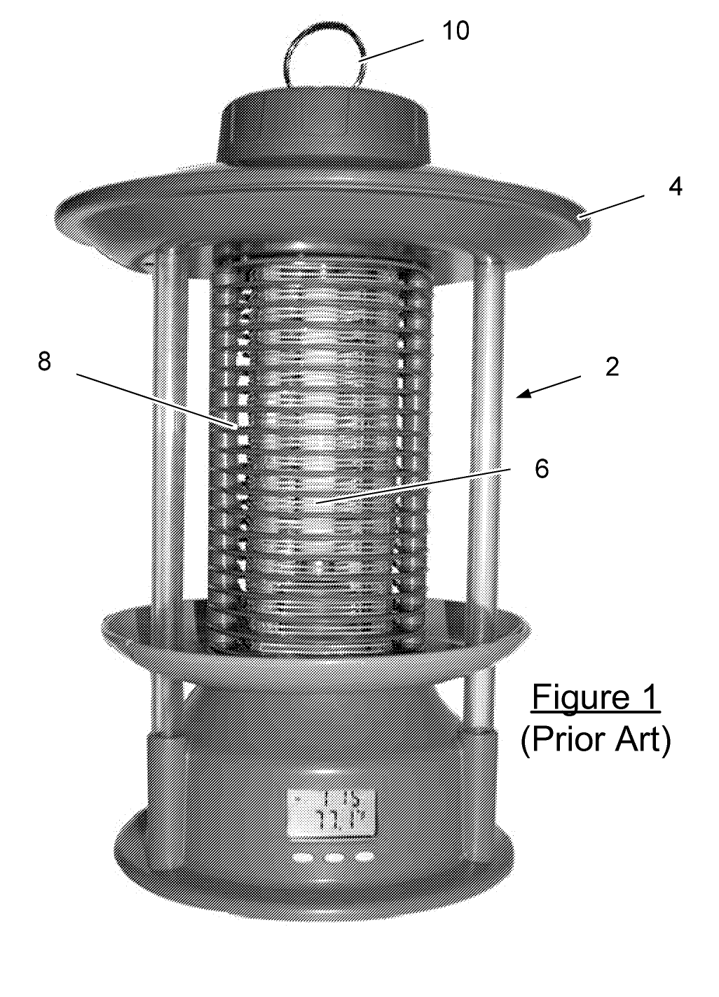

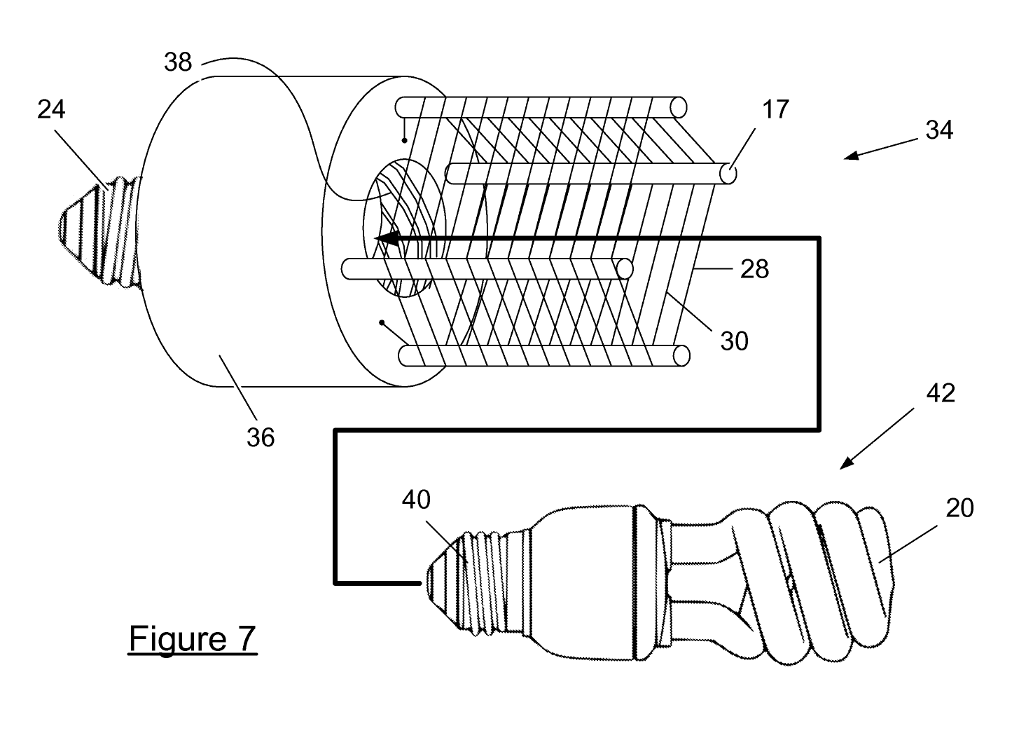

Referring now to FIG. 7, there is depicted a preferred embodiment of an insect killing apparatus 34 according to a further aspect of the present invention. In this figure like items to those shown in FIG. 1 have been labeled with the same identification numbers.

The apparatus 34 comprises a base 36 which is formed with an electrical socket 38 for receiving the electrical plug 40 of an electric light, such as compact fluorescent light 42.

A number of support posts 17 extend from one side of the base 36. Accordingly, when the light 42 is installed in the socket 38 the support posts extend about fluorescent tube 20 of the light. The support posts 17 support a pair of spaced apart electrodes in the form of coils 28 and 30 which coiled around the fluorescent tube 20 of the light 42. While electrodes in the form of spaced apart coils are shown in the preferred embodiment, other types of electrodes, for example grids of wire are also possible and envisaged in alternative embodiments of the invention.

The base 26 houses a first electric circuit being of the same type as circuit 22 shown in FIG. 3, which is coupled to socket 38 and arranged to energize the tube 20 of light 42 once it is installed into the base, so that the tube 20 produces light.

Also houses a second electric circuit being of the same type as circuit the second electric circuit 26 of FIG. 3. The second electric circuit is coupled to coils 28 and 30 and is arranged to produce a potential difference across the coils sufficient to kill an insect, such as a mosquito that comes into contact with both coils.

The first circuit, for powering the light 42, may be mounted to a first circuit board and the second circuit, for energizing the coils, may be mounted to a second circuit board. Alternatively, the first and second electric circuits may share a common circuit board or other support structure.

In use the light 42 is installed into the base 36 by screwing the connector 40 of the light into the socket 24 of the base 36 of the insect killing apparatus 34. The socket 24 of the base 36 is then installed into an electricity supply outlet so that the light 42 illuminates and the coils 28 and 30 become energized by operation of the first and second electrical circuits. In the event of the light 42 failing a replacement light can be installed into the base.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art.

For example, in the following claims, any of the claimed embodiments can be used in any combination.

1. An insect killing apparatus comprising:
a compact fluorescent light of a type including
a base defining a compartment containing a first electric circuit arranged to apply current to one or more fluorescent tubes of the light; and
an electrical connector coupled to the first electric circuit for attachment to an electric power supply outlet;
said killing apparatus further comprising;
a second electric circuit within the compartment arranged to produce a potential difference sufficient to kill a mosquito; and
first and second spaced apart electrodes disposed about said tubes and in electrical communication with the second electric circuit.

2. An apparatus according to claim 1, wherein one or more support members extend from the base for supporting the first and second electrodes.

3. An apparatus according to claim 1, wherein the first and second electric circuits share a common circuit board.

4. An apparatus according to claim 1, wherein the first and second electric circuits are disposed on corresponding separate circuit boards.

5. An apparatus according to claim 1 wherein the electrodes comprise coils and including an arrangement for spacing the coils from the fluorescent tubes.

6. An apparatus according to claim 5, wherein the arrangement for spacing the coils from the fluorescent tubes comprises a plurality of radial fins.

7. An apparatus according to claim 1 including a safety cover fitted about the electrodes.

8. An insect killing apparatus according to claim 1.

9. An insect killing apparatus comprising:
a base containing a first electric circuit arranged to power an electric light, the base including a socket for receiving an electricity plug of said electric light;
an electrical connector extending from the base for attachment to an electricity supply outlet;
the base further including;
a second electric circuit arranged to produce a potential difference capable of killing mosquitoes; and
first and second spaced apart electrodes extending from the base and in electrical communication with the second electric circuit.

10. An apparatus according to claim 9, including one or more support members extending from the base for supporting the first and second electrodes.

11. An apparatus according to claim 9, wherein the first and second electric circuits share a common circuit board or alternatively they may be disposed on corresponding separate circuit boards.

12. An apparatus according to claim 9, wherein the electrodes comprise coils.

13. A method for making an electric insect killing machine comprising the steps of:
locating a coil energizing circuit within a base compartment of a compact fluorescent lamp;
disposing a pair of spaced apart electrodes about fluorescent tubes of said lamp; and
placing the spaced apart electrodes in electrical communication with the coil energizing circuit.
